(19) United States
(12) Patent Application Publication
(10) Pub. No.: US 2007/0201400 A1
(43) Pub. Date: Aug. 30, 2007

(54) Opportunistic packet scheduling apparatus and method in multihop relay wireless access communication system

(75) Inventors: Hyun-Jeong Kang, Seoul (KR); Jae-Weon Cho, Suwon-si (KR); Jung-Je Son, Seongnam-si (KR); Pan-Yuh Joo, Seoul (KR); Dae-Hyoung Hong, Seoul (KR); Jin-Woo Choe, Seoul (KR); Byung-Wook Jun, Seoul (KR)

Correspondence Address: THE FARRELL LAW FIRM, P.C., 333 EARLE OVINGTON BOULEVARD, SUITE 701, UNIONDALE, NY, 11553, US

(73) Assignees: SAMSUNG ELECTRONICS CO., LTD., Suwon-si (KR); Industry-University Cooperation Foundation Sogang University, Seoul (KR)

(21) Appl. No.: 11/703,596

(22) Filed: Feb. 7, 2007

(30) Foreign Application Priority Data
Feb. 7, 2006 (KR) 2006-0011383

(51) Int. Cl. H04Q 7/00

(52) U.S. Cl. 370/329

(57) ABSTRACT

Opportunistic packet scheduling apparatus and method in a multihop relay wireless access communication system are provided. The method includes aggregating channel condition information which are estimated and reported by Mobile Stations (MSs) and a Relay Station (RS) for each MS path in a cell, determining a Modulation and Coding Scheme (MCS) level which corresponds to the aggregated channel condition information for a corresponding hop of each MS path, determining a transmittable coded packet size and a number of subchannels required for the packet transmission depending on the determined MCS level, and calculating a current radio resource efficiency of the corresponding MS path using the determined coded packet size and the determined number of the subchannels.

### PRIORITY

This application claims priority under 35 U.S.C. § 119 to an application filed in the Korean Intellectual Property Office on Feb. 7, 2006 and assigned Serial No. 2006-11383, the contents of which are incorporated herein by reference.

### BACKGROUND OF THE INVENTION

1. Field of the Invention The present invention relates generally to a multihop relay wireless access communication system, and in particular, to an opportunistic packet scheduling apparatus and method.

2. Description of the Related Art

Packet scheduling determines service orders of packets based on a priority metric. Using packet scheduling, a radio packet network transmission system aims to ensure Quality of Service (QoS), maximize efficiency of radio resources and enable fair resource allocation to users.

In a conventional cellular packet transmission system, an opportunistic scheduling scheme was suggested which reflects the channel condition between a base station and a mobile station. The opportunistic scheduling scheme generally determines a user to whom a data transmission opportunity is granted by reflecting the channel condition between the base station and the mobile station at every time slot in a Time Division Multiplexing (TDM) or Time Division Multiple Access (TDMA) system where a user's data packet is transmitted using a time division scheme. For instance, the data transmission opportunity in the corresponding time slot is given to a user who has the highest ratio of the current data transmission rate to the average data transmission rate among a plurality of mobile stations. Herein, the time slot or the time is the radio resource for the data transmission, and the channel condition is mostly represented as a maximum transmission rate possible between the base station and the mobile station at the current time point.

Representative examples of the opportunistic scheduling scheme include a Proportional Fair (PF) scheduling scheme and a Modified Largest Weighted Delay First (M-LWDF) scheduling scheme.

As to the PF scheduling algorithm, provided that there are N Mobile Stations (MSs) 103-1 through 103-N having data to transmit within a cell as shown in FIG. 1, Base Station (BS) 101 aggregates channel conditions from the N MSs 103-1 through 103-N and determines a maximum available data transmission rate Rᵢ(t) of each MS 103-1 through 103-N. Rᵢ(t), which is the amount of data transmittable per time unit (bit/sec), can be viewed as the data amount transmittable using a unit radio resource; that is, as the radio resource efficiency. i has a value ranging from 1 to N. Next, the BS 101 calculates a ratio of an instantaneous maximum transmission rate to the average transmission rate R̅ᵢ(t); that is,

$$\frac{{R}_{i} ( t )}{{\overline{R}}_{i} ( t )}$$

for each MS 103-1 through 103-N, and grants the data transmission opportunity in the corresponding time slot to the MS j having the greatest

$$\frac{{R}_{i} ( t )}{{\overline{R}}_{i} ( t )} .$$

The priority metric of the PF scheduling can be expressed as Equation (1).

$$j = max arg \frac{{R}_{i} ( t )}{{\overline{R}}_{i} ( t )} \qquad ( 1 )$$

Next, the BS 101 updates the average data transmission rate with respect to each MS i. In doing so, the average data transmission rate for the user i selected for the data transmission in the corresponding time slot is updated based on Equation (2), and the average data transmission rate for the other users i is update based on Equation (3).

$$\begin{matrix}{\overline{R}}_{i} ( t ) = ( 1 - \frac{1}{{t}_{C}} ) {\overline{R}}_{i} ( t - 1 ) + \frac{1}{{t}_{C}} {R}_{i} ( t - 1 ) & ( 2 ) \\ {\overline{R}}_{i} ( t ) = ( 1 - \frac{1}{{t}_{C}} ) {\overline{R}}_{i} ( t - 1 ) & ( 3 )\end{matrix}$$

In Equations (2) and (3), t_{c}, which is a weight constant, is related to a sliding window size for acquiring the average data transmission rate. Different values for t_{c} can be properly set according to the system.

The PF scheduling scheme can increase the system efficiency through a diversity gain by users and furnishes proportional fairness, which provides service to each MS in proportion to the average channel condition of the MSs.

The PF scheduling does not consider QoS with respect to the user, whereas the M-LWDF scheduling algorithm aims to guarantee QoS with respect to the user. The M-LWDF scheduling can be implemented by modifying the priority metric of the PF scheduling as Equation (4).

$$j = max arg \{ {γ}_{i} ( t ) {W}_{i} ( t ) {R}_{i} ( t ) \} , {γ}_{i} ( t ) = \frac{{a}_{i}}{{\overline{R}}_{i} ( t )} \qquad ( 4 )$$

In Equation (4), aᵢ is a QoS parameter required by the user i, and Wᵢ is a time delay of a Head-Of-Line (HOL) packet in a queue of the MS i up to the time slot t. The M-LWDF scheduling scheme can contribute to the QoS guarantee of the packet by reflecting aᵢ and Wᵢ to the scheduling priority metric, and achieve the system efficiency increase and the proportional fairness, like the PF scheduler, by virtue of the opportunistic scheduling.

Recently, for the sake of the coverage expansion and the system efficiency increase from the single-hop transmission in the radio packet transmission system, multihop transmission via Relay Stations (RSs) 203-1 through 203-N-1 is under consideration as shown in FIG. 2. Referring to FIGS. 2 and 3, in the multihop relay network system, MS 205 and the RSs 203-1 through 203-N-1 within the cell, continuously estimate their channel condition 305-1 through 305-4 and RS 303 and report their estimated channel condition to the BS 301. The BS 201 performs the centralized packet scheduling based on the channel condition of the links in the cell. Herein, it is assumed that the routing between the BS 201 and the MS 205 is performed in a separate process by considering the channel condition.

To implement the packet scheduling in the radio multihop relay network, one may consider adopting the opportunistic scheduling scheme of the existing cellular system. In the existing cellular system, as shown in FIG. 1, since the BS 101 is connected directly to the MSs 103-1 through 103-N by a single link, there is no complication when determining the maximum available data transmission rate Rᵢ(t) which is the crucial factor of the priority metric for the scheduling. However, when the opportunistic scheduling scheme is applied directly to the radio multihop relay network, there may be several ways to determine Rᵢ(t) because the multihop paths can be established between the BS 201 and the MS 205.

For instance, Rᵢ(t) can be determined by merely reflecting the channel condition of a specific hop link; that is, the channel condition of an initial hop or a final hop in the path between the BS and the MS. Yet, if only the channel condition of the corresponding link of the links between the BS and the MS abruptly degrades or improves, Rᵢ(t) cannot properly reflect the channel condition of the whole hop on the path, which is opposed to the concept of the opportunistic scheduling that reflects the current channel condition between the MS and the BS. That is, when the packet scheduling is performed based on the incorrect channel information of the path, the gain of the user diversity and the system efficiency may both decrease. Also, according to which path is used or how many hops of the link are passed through for the data transmission between the BS and the MS, the quantity of the radio resource consumed to send the unit data may differ. Nevertheless, this is not reflected in the packet scheduling, thus deteriorating the evenness of the radio resource distribution to the MS.

Therefore, to apply the opportunistic scheduling scheme of the existing cellular system to the wireless multihop relay network, it is required to define a metric which integrally quantizes the channel condition of all links along the data transmission path between the BS and the MS and the quantity of the radio resource needed to send the corresponding data, and to reflect the defined metric to the scheduling.

### SUMMARY OF THE INVENTION

An aspect of the present invention is to substantially solve at least the above problems and/or disadvantages and to provide at least the advantages below. Accordingly, an aspect of the present invention is to provide an opportunistic packet scheduling apparatus and method in a multihop relay wireless access communication system.

Another aspect of the present invention is to provide an apparatus and method for expanding and applying an opportunistic scheduling scheme of an existing cellular system to a multihop relay wireless access communication system.

A further aspect of the present invention is to provide an apparatus and method for adopting an opportunistic scheduling scheme by reflecting channel condition of all links along multiple hops in a multihop relay wireless access communication system.

The above aspects are achieved by providing an opportunistic packet scheduling method in a multihop relay wireless access communication system, which includes aggregating channel condition information which are estimated and reported by MSs and an RS for each MS path in a cell, determining a Modulation and Coding Scheme (MCS) level which corresponds to the aggregated channel condition information for a corresponding hop of each MS path, determining a transmittable coded packet size and a number of subchannels required for the packet transmission depending on the determined MCS level, and calculating a current radio resource efficiency of the corresponding MS path using the determined coded packet size and the determined number of the subchannels.

According to the present invention, an opportunistic packet scheduling apparatus in a multihop relay wireless access communication system, includes a current radio resource efficiency calculator which calculates a current radio resource efficiency value using channel condition information received from MSs and an RS in a cell, and outputs the calculated current radio resource efficiency value to a scheduling priority metric calculator and an average radio resource efficiency calculator, the scheduling priority metric calculator which calculates a scheduling priority metric using a current radio resource efficiency value at a time t, which is provided from the current radio resource efficiency calculator, and an average radio resource efficiency value at a time t−1, which is provided from the average radio resource efficiency calculator, and outputs the calculated priority metric to a maximum priority metric user selector, the average radio resource efficiency calculator which calculates and updates an average wireless radio efficiency value using the current radio resource efficiency value fed from the current radio resource efficiency calculator, and user information scheduled for a current frame, which is provided from the maximum priority metric user selector, and outputs the calculated average radio resource efficiency value to the scheduling priority metric calculator, and the maximum priority metric user selector which selects a user having a maximum priority metric from the scheduling priority metrics fed from the scheduling priority metric calculator, and outputs status information of the selected user from a user queue to the average radio resource efficiency calculator.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a conventional cellular system;

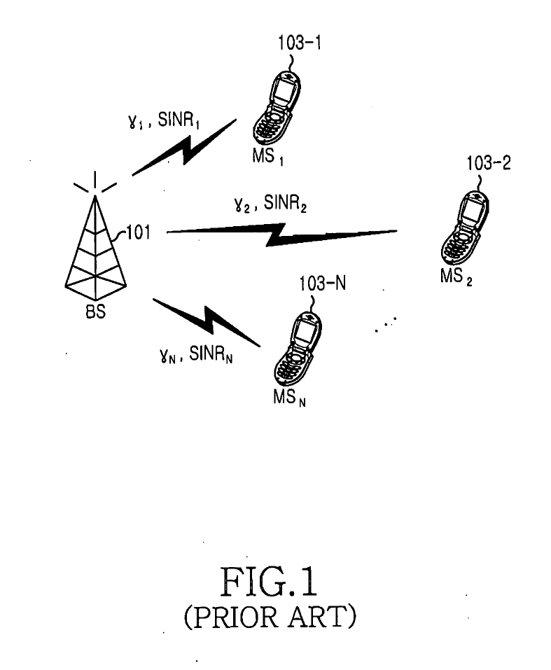

FIG. 2 illustrates a multihop relay network system according to the present invention;

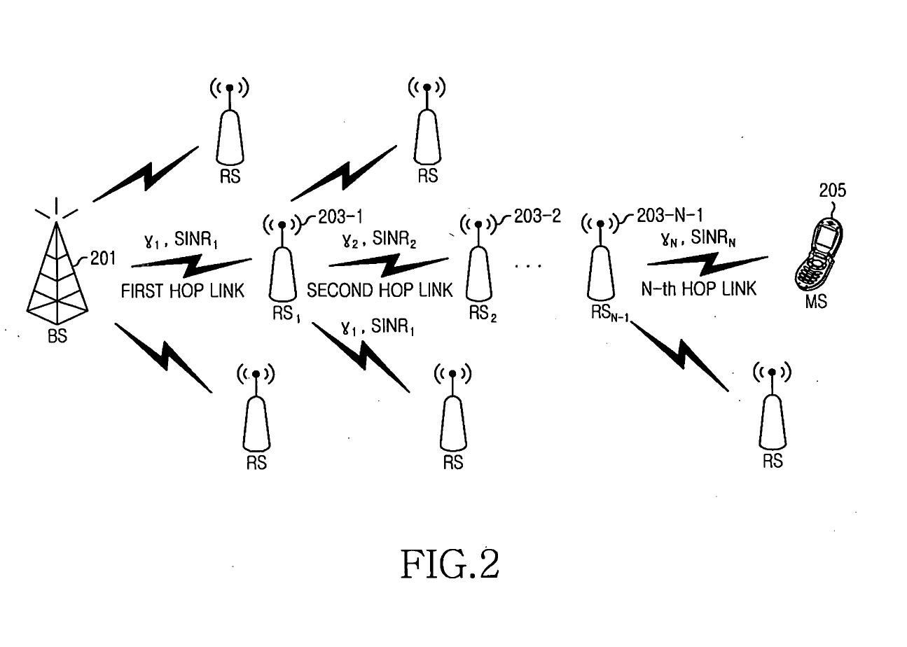

FIG. 3 illustrates a channel condition reporting process in a wireless multihop relay network environment according to the present invention;

FIG. 4 illustrates an opportunistic packet scheduling apparatus in the multihop relay wireless access communication system according to the present invention; and

FIG. 5 illustrates an opportunistic packet scheduling method in the multihop relay wireless access communication system according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail for the sake of clarity and conciseness.

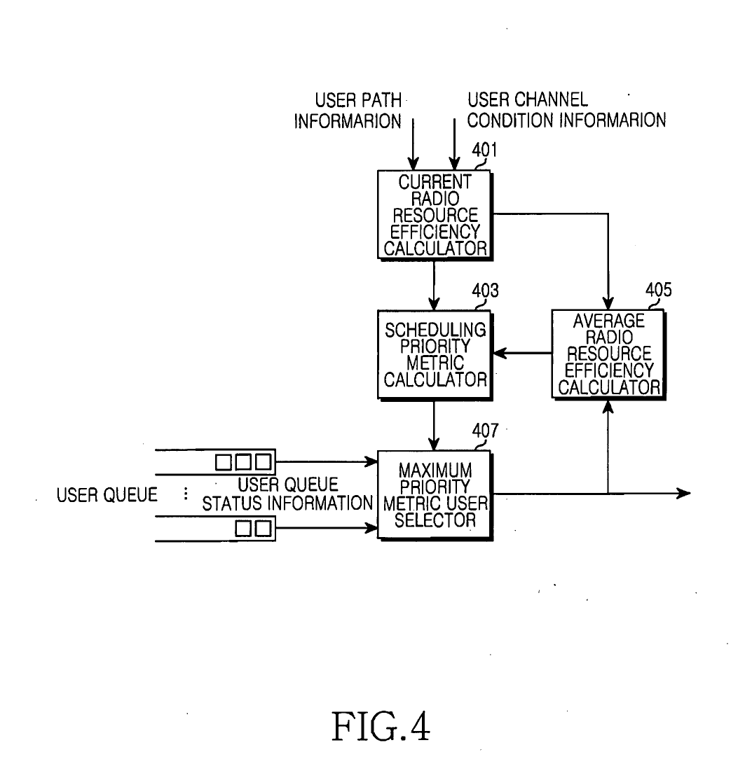

FIG. 4 is a block diagram of an opportunistic packet scheduling apparatus in a multihop relay wireless access communication system according to the present invention. The opportunistic packet scheduling apparatus includes a current radio resource efficiency calculator 401, a scheduling priority metric calculator 403, an average radio resource efficiency calculator 405 and a maximum priority metric user selector 407.

Referring to FIG. 4, the current radio resource efficiency calculator 401 calculates a current radio resource efficiency value using channel condition information received from MSs and an RS within a cell; that is, the calculation is performed using information relating to an MS set having packets to transmit at a time t within the cell and Signal to Interference and Noise Ratio (SINR) of each link, and providing the calculated current radio resource efficiency value to the scheduling priority metric calculator 403 and the average radio resource efficiency calculator 405. Specifically, the current radio resource efficiency calculator 401 determines an MCS level corresponding to the SINR of the link for each MS, calculates the packet size coded according to the MCS level and the total number of subchannels, and calculates the radio resource efficiency value of the corresponding BS-MS path using the calculated coded packet size and the calculated number of the subchannels.

The scheduling priority metric calculator 403 calculates a scheduling priority metric using the current radio resource efficiency value at the time t, which is fed from the current radio resource efficiency calculator 401, and an average radio resource efficiency value at a time t−1, which is fed from the average radio resource efficiency calculator 405, and outputs the calculated priority metric to the maximum priority metric user selector 407.

The average radio resource efficiency calculator 405 calculates and updates the average radio resource efficiency value using the current radio resource efficiency value fed from the current radio resource efficiency calculator 401 and information relating to the user scheduled for the current frame, which is fed from the maximum priority metric user selector 407, and outputs the calculated average radio resource efficiency value to the scheduling priority metric calculator 403.

The maximum priority metric user selector 407 selects a user having the maximum priority metric from the scheduling priority metrics provided from the scheduling priority metric calculator 403, and gives the data transmission opportunity to the selected user. Also, the maximum priority metric user selector 407 receives an input parameter value for calculating an average radio resource efficiency of the selected user; that is, the corresponding packet size and the number of subchannels from a user queue (not shown), and forwards them to the average radio resource efficiency calculator 405.

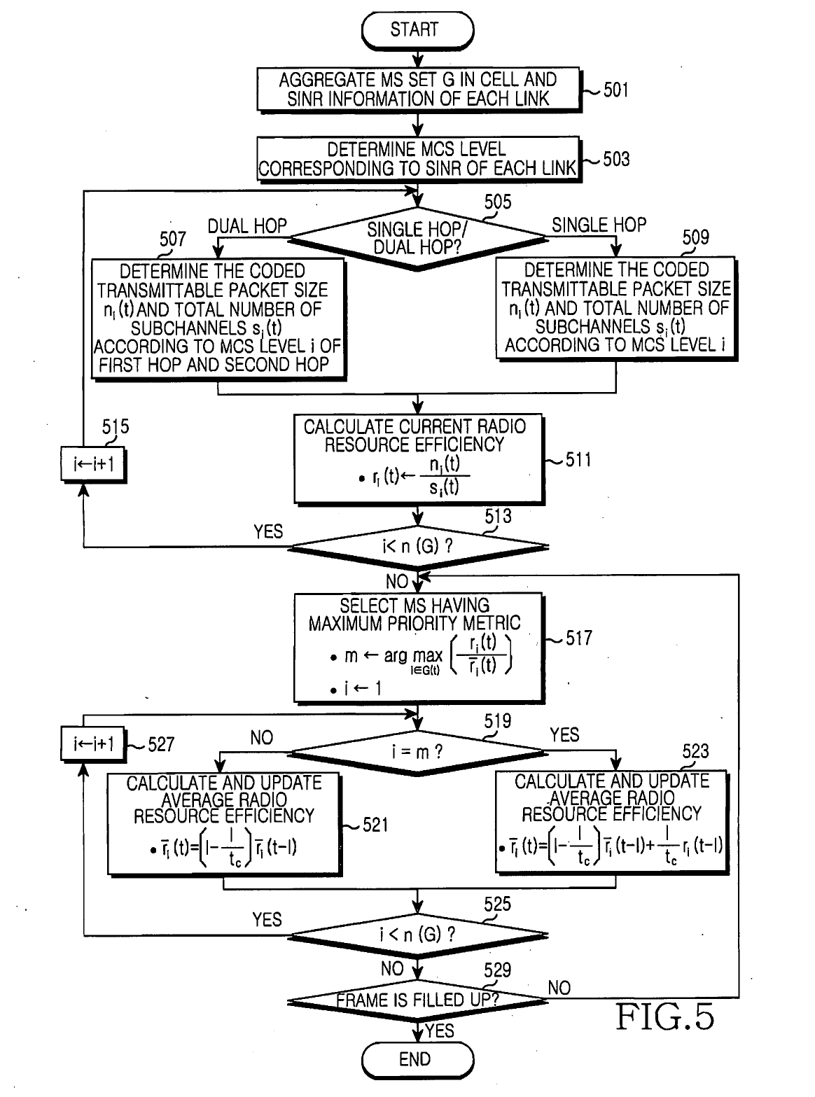

FIG. 5 illustrates an opportunistic packet scheduling method in the multihop relay wireless access communication system according to the present invention. Herein, the system adopts a Time Division Duplex (TDD)/Orthogonal Frequency Division Multiple Access (OFDMA) scheme and operates in a diversity mode. RS is located in a first tier based on BS. Data between the BS and MS is transmitted on the single hop from the BS to the MS, or on dual hops via the RS. It is assumed that the transmission path between the BS and the MS is determined in a separate process. It is assumed that the system selects an MS to transmit data and data to be transmitted in the present frame using the centralized opportunistic scheduling scheme, the corresponding data is delivered to the destination through every hop link within one frame period, and the channel condition during one frame does not change. Herein, the frame has a time axis and a frequency axis in two dimensions, and a fundamental unit of the frame is a subchannel.

Referring now to FIG. 5, a BS scheduler collects channel condition information estimated and reported by the MSs and the RS in the cell, for the packet scheduling for one frame packet in step 501. That is, the BS scheduler aggregates an MS set G(t) having packets to transmit at the time t in the cell and the SINR information of each link.

In step 503, the BS scheduler determines an MCS level corresponding to the collected link SINRs. In doing so, the MS index i is set to ‘1’.

The MCS level can be determined using Table 1, which shows the modulation, code rate, coded packet size, number of subchannels required to transmit the corresponding coded packet, and required SINR depending on the MCS level.

TABLE 1

| | | | Set A | | Set B | | |
|---|---|---|---|---|---|---|---|
| | | | Size of | Number of | Size of | Number of | |
| | | | coded | subchannels | coded | subchannels | Required SINR |
| MCS | | Code | packet | for | packet | for | [dB] |
| level | Modulation | rate | [bit] | transmission | [bit] | transmission | (Ped-A, 3 km/h) |
| 1 | QPSK | 1/12 | 288 | 36 | 8 | 1 | −3.95 |
| 2 | | 1/6 | 384 | 24 | 16 | 1 | −1.65 |
| 3 | | 1/3 | 480 | 15 | 32 | 1 | 1.5 |
| 4 | | 1/2 | 480 | 10 | 48 | 1 | 4.3 |
| 5 | | 2/3 | 960 | 15 | 64 | 1 | 7.95 |
| 6 | 16QAM | 1/2 | 960 | 10 | 96 | 1 | 9.3 |
| 7 | | 2/3 | 960 | 8 | 128 | 1 | 13.1 |
| 8 | | 5/8 | 960 | 8 | 144 | 1 | 15.8 |
| 9 | 64QAM | 2/3 | 960 | 5 | 192 | 1 | 18.45 |
| 10 | | 5/6 | 960 | 4 | 240 | 1 | 24.8 |

In Table 1, the size of the coded packet and the number of the subchannels required for the transmission can be classified as Set A and Set B based on granularity of the coded packet. The following provides a description of Set B.

The BS scheduler calculates a current radio resource efficiency rᵢ(t) in steps 505 through 511. Herein, the radio resource efficiency can be defined as the amount of data transmittable per unit time in a unit band; that is, the amount of data transmittable using a unit radio resource along a path between the BS and a MS i. The unit of the radio resource efficiency can be [bit]/[Hz][Sec] or [bps]/[Hz]. Here,

$$\frac{1}{{r}_{i} ( t )}$$

is the amount of radio resource required to transmit 1-bit data. Provided that a hop route is set between the BS and the MS for the data transmission in the wireless multihop relay system, the amount of the radio resource required to transmit 1-bit data between the BS and the MS can be expressed as the summation of the radio resources at every hop along the route; that is,

$${\sum }_{j = 1}^{{N}_{i}} \frac{1}{{r}_{i , j} ( t )}$$

where r_{i,j}(t) is the radio resource efficiency at the j-th hop of the MS i at the time t. Accordingly, the radio resource efficiency of the route between the BS and the MS i at the time t can be expressed as Equation (5).

$${r}_{i} ( t ) = {( {\sum }_{j = 1}^{{N}_{i}} \frac{1}{{r}_{i , j} ( t )} )}^{- 1} \qquad ( 5 )$$

As such, by reflecting the channel condition of every hop along the route, the data amount transmittable per unit radio resource in the multihop path can be quantized to one value. In steps 505 through 511, the current radio resource efficiency calculation for the single hop path and the dual-hop path is described by applying the above scheme by way of example.

In step 505, the BS scheduler determines whether the data transmission between the BS and the corresponding MS is conducted directly on the single hop or through the dual-hop path via the RS.

When the data is transmitted from the BS to the corresponding MS via the RS along the dual-hop path in step 505, the BS scheduler determines the size of the coded transmittable packet nᵢ(t) and the total number of the subchannels sᵢ(t) required to transmit the packet in the frame according to the MCS levels of the first hop and the second hop with respect to the MS i in step 507.

The coded packet size and the total number of the subchannels according to the MCS levels of the first hop and the second hop can be determined using Table 2 and Table 3.

TABLE 2

| MCS level of | MCS level of second hop | | | | | | | | | |
|---|---|---|---|---|---|---|---|---|---|---|
| first hop | 1 | 2 | 3 | 4 | 5 | 6 | 7 | 8 | 9 | 10 |
| 1 | 2 | 3 | 5 | 7 | 9 | 13 | 17 | 19 | 25 | 31 |
| 2 | 3 | 2 | 3 | 4 | 5 | 7 | 9 | 10 | 13 | 16 |
| 3 | 5 | 3 | 2 | 2.5 | 3 | 4 | 5 | 5.5 | 7 | 8.5 |
| 4 | 7 | 4 | 2.5 | 2 | 2.33 | 3 | 3.66 | 4 | 5 | 6 |
| 5 | 9 | 5 | 3 | 2.33 | 2 | 2.5 | 3 | 3.25 | 4 | 4.75 |
| 6 | 13 | 7 | 4 | 3 | 2.5 | 2 | 2.33 | 2.5 | 3 | 3.5 |
| 7 | 17 | 9 | 5 | 3.66 | 3 | 2.33 | 2 | 2.125 | 2.5 | 2.875 |
| 8 | 19 | 10 | 5.5 | 4 | 3.25 | 2.5 | 2.125 | 2 | 2.33 | 2.66 |
| 9 | 25 | 13 | 7 | 5 | 4 | 3 | 2.5 | 2.33 | 2 | 2.25 |
| 10 | 31 | 16 | 8.5 | 6 | 4.75 | 3.5 | 2.875 | 2.66 | 2.25 | 2 |

TABLE 3

| MCS level of | MCS level of second hop | | | | | | | | | |
|---|---|---|---|---|---|---|---|---|---|---|
| first hop | 1 | 2 | 3 | 4 | 5 | 6 | 7 | 8 | 9 | 10 |
| 1 | 8 | 16 | 32 | 48 | 64 | 96 | 128 | 144 | 192 | 240 |
| 2 | 16 | 16 | 32 | 48 | 64 | 96 | 128 | 144 | 192 | 240 |
| 3 | 32 | 32 | 32 | 48 | 64 | 96 | 128 | 144 | 192 | 240 |
| 4 | 48 | 48 | 48 | 48 | 64 | 96 | 128 | 144 | 192 | 240 |
| 5 | 64 | 64 | 64 | 64 | 64 | 96 | 128 | 144 | 192 | 240 |
| 6 | 96 | 96 | 96 | 96 | 96 | 96 | 128 | 144 | 192 | 240 |
| 7 | 128 | 128 | 128 | 128 | 128 | 128 | 128 | 144 | 192 | 240 |
| 8 | 144 | 144 | 144 | 144 | 144 | 144 | 144 | 144 | 192 | 240 |
| 9 | 192 | 192 | 192 | 192 | 192 | 192 | 192 | 192 | 192 | 240 |
| 10 | 240 | 240 | 240 | 240 | 240 | 240 | 240 | 240 | 240 | 240 |

When the data is transmitted directly from the BS to the MS on the single hop in step 505, the BS scheduler determines the size of the transmittable coded packet nᵢ(t) and the total number of the subchannels sᵢ(t) required to transmit the packet in the frame according to the MCS level of the MS i in step 509. The coded packet size and the total number of the subchannels according to the MCS level of the MS i can be determined based on Table 1.

In step 511, the BS scheduler calculates the current radio resource efficiency. The radio resource efficiency of the BS-MS path is acquired using the determined coded packet size nᵢ(t) and the determined number of the required subchannels Sᵢ(t).

The radio resource efficiency rᵢ(t) of the path from the BS to the i-th MS at the time t can be calculated based on Equation (6)

$${r}_{i} ( t ) = \frac{{n}_{i} ( t )}{{s}_{i} ( t )} \qquad ( 6 )$$

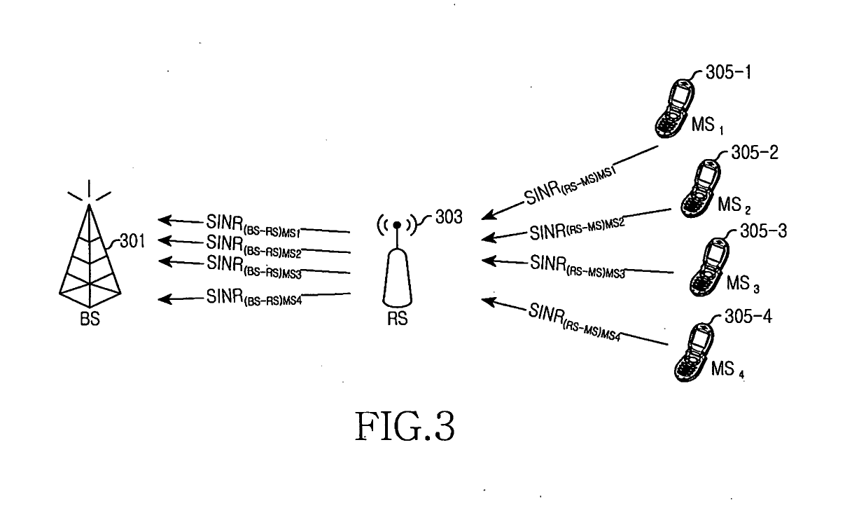

For instance, as shown in FIG. 3, in a system where there are four MSs 305-1 through 305-4 having data to transmit in the cell and data are transmitted between a BS 301 and the MSs 305-1 through 305-4 via an RS 303 along dual-hop paths, it is assumed that channel condition information collected from the MSs 305-1 through 305-4 are arranged as set forth in Table 4.

TABLE 4

| MS index | SINR[dB] of first hop link | SINR[dB] of second hop link |
|---|---|---|
| 1 | 16.00 | 2.00 |
| 2 | 16.00 | 5.30 |
| 3 | 5.00 | 5.20 |
| 4 | 10.00 | 12.00 |

The MCS level of each hop link of each MS can be determined as set forth in Table 5 based on Table 1.

TABLE 5

| MS index | SINR[dB] of first hop link | SINR[dB] of second hop link |
|---|---|---|
| 1 | 8 | 3 |
| 2 | 8 | 4 |
| 3 | 4 | 4 |
| 4 | 6 | 6 |

Based on Table 2 and Table 3, it is possible to determine the coded packet size and the total number of the subchannels depending on the MCS levels of the first hop link and the second hop link of each MS as shown in Table 6. With the determined coded packet size nᵢ(t) and the determined total number of the subchannels sᵢ(t), the radio resource efficiency of the BS-MS path can be calculated based on Equation (6).

TABLE 6

| | | | (transmittable coded |
|---|---|---|---|
| | | Transmittable | packet size)/ |
| | Total number of | coded packet | (total number |
| MS index | subchannels | size | of subchannels) |
| 1 | 5.5 | 144 | 26.2 |
| 2 | 4.0 | 144 | 36.0 |
| 3 | 2.0 | 48 | 24.0 |
| 4 | 2.0 | 96 | 48.0 |

Next, in step 513, the BS scheduler determines whether i is less than the number of MS sets n(G) in the cell. When i is less than n(G), the BS scheduler updates i to i+1 in step 515 and returns to the step 505 to repeat the operations for every MS.

When i is greater than or equal to n(G) in step 513, the BS scheduler determines that the radio resource efficiency has been calculated for every MS in the MS set and calculates the priority metric; that is, the ratio of the current radio resource efficiency to the average radio resource efficiency

$$\frac{{r}_{i} ( t )}{{\overline{r}}_{i} ( t )}$$

for each MS in step 517. Also, the BS scheduler selects an MS having the maximum priority metric from the calculated priority metrics and grants the data transmission opportunity to the selected MS. In doing so, the BS scheduler resets i to ‘1’ to update the average radio resource efficiency for every.MS.

The MS having the maximum priority metric can be selected based on Equation (7).

$$m = arg max ( \frac{{r}_{i} ( t )}{{\overline{r}}_{i} ( t )} ) \qquad ( 7 )$$

In Equation (7), m denotes the selected MS at the time t.

Specifically, when the average radio resource efficiency of each MS is shown in Table 7, the data transmission opportunity can be given to a first MS having the highest priority metric 1.4465 amongst the MSs.

TABLE 7

| | Instantaneous radio | Average radio | Priority |
|---|---|---|---|
| MS index | resource efficiency | resource efficiency | metric |
| 1 | 26.18 | 18.10 | 1.4465 |
| 2 | 36.00 | 35.40 | 1.0169 |
| 3 | 24.00 | 23.00 | 1.0435 |
| 4 | 48.00 | 50.00 | 0.9600 |

Next, the BS scheduler determines whether i is the MS m selected at the time t; that is, the MS m given the data transmission opportunity in the present scheduling in step 519. When i is (or equals) m, the BS scheduler calculates and updates the average radio resource efficiency based on Equation (8) in step 523. When i is not m, the BS scheduler calculates and updates the average radio resource efficiency based on Equation (9) in step 521.

$$\begin{matrix}{\overline{r}}_{i} ( t ) = ( 1 - \frac{1}{{t}_{C}} ) {\overline{r}}_{i} ( t - 1 ) + \frac{1}{{t}_{C} {r}_{i} ( t - 1 )} & ( 8 ) \\ {\overline{r}}_{i} ( t ) = ( 1 - \frac{1}{{t}_{C}} ) {\overline{r}}_{i} ( t - 1 ) & ( 9 )\end{matrix}$$

In Equations (8) and (9), t_{c}, which is a weight constant, is related to the sliding window size to calculate the average value. A proper value can selected as t_{c} according to the system.

In the above example, when t_{c} is set to 100, the average radio resource efficiency of the first MS is updated to (0.99)(18.10)+(0.01)(26.18)≈18.18. Of the other unselected MSs, the average radio resource efficiency of the second MS is updated to (0.99)(35.40)≈35.05, the average radio resource efficiency of the third MS is updated to (0.99)(23.00)≈22.77, and the average radio resource efficiency of the fourth MS is updated to (0.99)(50.00)≈49.50.

Next, the BS scheduler determines whether i is less than the number of the MS sets in the cell n(G) in step 525. When i is less than n(G), the BS scheduler updates i to i+1 in step 527 and returns to the step 519 to determine whether i is m. When i is greater than or equal to n(G), the BS scheduler checks whether the frame is full in step 529. When the frame is not full, the BS scheduler returns to the step 517 and selects an MS having the maximum priority metric from the unselected MSs. In the system according to the present invention, since it is assumed that the channel condition does not change during one frame, the MSs retain the same radio resource efficiency within one frame and the scheduling is repeated until data is transmitted using the available subchannels at maximum in the frame. When the frame is occupied; that is, when the scheduling for one frame is completed, the BS scheduling terminates the algorithm of the present invention.

As set forth above, in the multihop relay wireless access communication system, the apparatus and the method for expanding and applying the opportunistic scheduling scheme of the existing cellular system can raise the system efficiency by virtue of the centralized opportunistic scheduling implementation and enhance the fairness of the radio resource distribution.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An opportunistic packet scheduling method in a multihop relay wireless access communication system, comprising:
aggregating channel condition information that is estimated and reported by Mobile Stations (MSs) and a Relay Station (RS) for each MS path in a cell;
determining a Modulation and Coding Scheme (MCS) level that corresponds to the aggregated channel condition information for a corresponding hop of each MS path;
determining a transmittable coded packet size and a number of subchannels required for the packet transmission depending on the determined MCS level; and
calculating a current radio resource efficiency of the corresponding MS path using the determined coded packet size and the determined number of the subchannels.

2. The opportunistic packet scheduling method of claim 1, wherein the current radio resource efficiency for each MS path is calculated as a summation of numbers of subchannels required for the transmission of the size-determined packet on each hop.

3. The opportunistic packet scheduling method of claim 1, further comprising:
calculating a ratio of a current radio resource efficiency to an average radio resource efficiency for each MS;
selecting an MS having a largest ratio of the current radio resource efficiency to the average radio resource efficiency and scheduling the selected MS; and
updating an average radio resource efficiency of the MSs.

4. The opportunistic packet scheduling method of claim 3, wherein the average radio resource of the selected MS is updated based on the following equation:
$${\overline{r}}_{i} ( t ) = ( 1 - \frac{1}{{t}_{C}} ) {\overline{r}}_{i} ( t - 1 ) + \frac{1}{{t}_{C}} {r}_{i} ( t - 1 ) ,$$
and the average radio resource efficiency of an unselected MS is updated based on the following equation:
$${\overline{r}}_{i} ( t ) = ( 1 - \frac{1}{{t}_{C}} ) {\overline{r}}_{i} ( t - 1 )$$
where t_{c} is a weight constant, r̅ᵢ(t) is an average radio resource efficiency, and rᵢ(t) is a current radio resource efficiency.

5. An opportunistic packet scheduling apparatus in a multihop relay wireless access communication system, comprising:
a current radio resource efficiency calculator which calculates a current radio resource efficiency value using channel condition information received from Mobile Stations (MSs) and a Relay Station (RS) in a cell, and outputs the calculated current radio resource efficiency value to a scheduling priority metric calculator and an average radio resource efficiency calculator;
the scheduling priority metric calculator which calculates a scheduling priority metric using a current radio resource efficiency value at a time t, which is provided from the current radio resource efficiency calculator, and an average radio resource efficiency value at a time t-1, which is provided from the average radio resource efficiency calculator, and outputs the calculated priority metric to a maximum priority metric user selector;
the average radio resource efficiency calculator which calculates and updates an average wireless radio efficiency value using the current radio resource efficiency value fed from the current radio resource efficiency calculator, and user information scheduled for a current frame, which is provided from the maximum priority metric user selector, and outputs the calculated average radio resource efficiency value to the scheduling priority metric calculator; and
the maximum priority metric user selector which selects a user having a maximum priority metric from the scheduling priority metrics fed from the scheduling priority metric calculator, and outputs status information of the selected user from a user queue to the average radio resource efficiency calculator.

6. The opportunistic packet scheduling apparatus of claim 5, wherein the channel condition information received from the MSs and the RS relates to an MS set having packets to transmit at a time t in the cell, and a Signal to Interference and Noise Ratio (SINR) of each link.

7. The opportunistic packet scheduling apparatus of claim 6, wherein the current radio resource efficiency calculator determines a Modulation and Coding Scheme (MCS) level corresponding to the SINR of each link for each MS, calculates a coded packet size and a total number of subchannels according to the MCS level, and calculates a radio resource efficiency value of a path between a Base Station (BS) and a corresponding MS using the calculated coded packet size and the calculated number of the subchannels.

8. An apparatus for opportunistic packet scheduling in a wireless access communication system, comprising:
means for aggregating channel condition information that is estimated and reported by Mobile Stations (MSs) and a Relay Station (RS) for each MS path in a cell;
means for determining a Modulation and Coding Scheme (MCS) level that corresponds to the aggregated channel condition information for a corresponding hop of each MS path;
means for determining a transmittable coded packet size and a number of subchannels required for the packet transmission depending on the determined MCS level; and
means for calculating a current radio resource efficiency of the corresponding MS path using the determined coded packet size and the determined number of the subchannels.

9. The apparatus claim 8, wherein the current radio resource efficiency for each MS path is calculated as a summation of numbers of subchannels required for the transmission of the size-determined packet on each hop.

10. The apparatus claim 8, further comprising:
means for calculating a ratio of a current radio resource efficiency to an average radio resource efficiency for each MS;
means for selecting an MS having a largest ratio of the current radio resource efficiency to the average radio resource efficiency and scheduling the selected MS; and
means for updating an average radio resource efficiency of the MSs.

11. The apparatus of claim 10, wherein the average radio resource of the selected MS is updated based on the following equation:
$${\overline{r}}_{i} ( t ) = ( 1 - \frac{1}{{t}_{C}} ) {\overline{r}}_{i} ( t - 1 ) + \frac{1}{{t}_{C}} {r}_{i} ( t - 1 ) ,$$
and the average radio resource efficiency of an unselected MS is updated based on the following equation:
$${\overline{r}}_{i} ( t ) = ( 1 - \frac{1}{{t}_{C}} ) {\overline{r}}_{i} ( t - 1 )$$
where t_{c} is a weight constant, r̅ᵢ(t) is an average radio resource efficiency, and rᵢ(t) is a current radio resource efficiency.
